(19) United States
(12) Patent Application Publication
(10) Pub. No.: US 2005/0170048 A1
(43) Pub. Date: Aug. 4, 2005

(54) Colorless, carbonated, and flavored beverages and methods of making the same

(75) Inventors: Peter L. Reynolds, Marietta, GA (US); Wayne D. Whisman, New Baltimore, MI (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: RWI Resources, Inc.

(21) Appl. No.: 11/049,139

(22) Filed: Feb. 2, 2005

Related U.S. Application Data
(60) Provisional application No. 60/541,031, filed on Feb. 2, 2004.
(60) Provisional application No. 60/624,907, filed on Nov. 4, 2004.

(51) Int. Cl. A23L 1/30

(52) U.S. Cl. 426/72

(57) ABSTRACT

Colorless, flavored, and carbonated beverages are disclosed, where at least one exemplary beverage includes at least 5% of the dietary reference daily intake (RDI) for a nutrient selected from an essential vitamin and an essential mineral, the 5% of the RDI for a specified nutrient being from a naturally-occurring source, and the naturally-occurring source being chosen from acerola juice, acerola juice concentrate, acerola powder extract, and combinations thereof. Also disclosed is a process for making a nutritive beverage product, the process including the steps of combining acerola juice and carbonated water and adjusting acerola juice concentration in the combination of acerola juice and carbonated water to yield at least 5% of dietary reference daily intake (RDI) of Vitamin C.

### CROSS-REFERENCE TO RELATED APPLICATION

This application claims priority to copending U.S. provisional application entitled, “Colorless, Carbonated, and Flavored Beverage,” having ser. No. 60/541,031 filed Feb. 2, 2004, and U.S. provisional application entitled, “Colorless, Carbonated, and Flavored Beverage,” having ser. No. 60/624,907, filed Nov. 4, 2004, both of which are entirely incorporated herein by reference.

### TECHNICAL FIELD

This disclosure is generally related to beverage products, processes for making beverage products, and, more particularly, is related to colorless, carbonated, and flavored beverages and methods of making same.

### BACKGROUND

The production of beverages has grown increasingly complex. Today's consumers drink a widening array of beverages with different flavors and formulations. Many of these consumers are consuming fruit juices for taste as well as nutritional reasons.

Commercially produced fruit juice beverages are typically made with either concentrate mixed with water or single strength juice. Beverages manufactured from juice concentrates are made by concentrating fruit juice, reconstituting the juice, and adding flavorings and/or other additives to form a finished fruit juice, which may then be packaged and stored. The juice may also be treated as needed to remove undesirable components such as bitterness components to make the finished juice beverage more palatable.

In today's fast-paced environment, individuals often drink their beverages “on the go” and are more often seeking beverages that are not only tasteful, but also offer some value in terms of adding to their recommended dietary reference daily intake (RDI). In the food industry, there is a constant demand for the production of additives, whether naturally-occurring or synthetic, which are capable of imparting, supplementing, or improving the flavor and nutrient value of the foodstuffs. It is common in some segments of the industry to add flavor agents to enhance or bring out desirable characteristics in products and, by so doing, render the product more desirable from a consumer preference standpoint. In this regard, “soft drinks” (i.e., carbonated beverages) still have a strong appeal to many individuals for taste reasons.

Accordingly, there is a need for a beverage and a system for enhancing the nutritive value that a beverage or soft drink can offer an individual.

### SUMMARY

Briefly described, embodiments of the present disclosure include beverage products and methods related to producing beverages. Specifically, one exemplary beverage includes a colorless, flavored, and carbonated beverage. Another exemplary beverage includes at least 5% of the dietary reference daily intake (RDI) for a nutrient selected from an essential vitamin and an essential mineral, the 5% of the RDI for a specified nutrient being from a naturally-occurring source, and the naturally-occurring source being chosen from acerola juice, acerola juice concentrate, acerola powder extract, and combinations thereof.

Also included in the present disclosure are processes and methods for producing beverages. One exemplary process includes combining acerola juice and carbonated water and adjusting acerola juice concentration in the combination of acerola juice and carbonated water to yield at least 5% of dietary reference daily intake (RDI) of Vitamin C.

Other beverages, methods, features, and advantages of the present disclosure will be or will become apparent to one with skill in the art upon examination of the following drawings and detailed description. It is intended that all such additional beverages, methods, features, and advantages be included within this description, be within the scope of the present disclosure, and be protected by the accompanying claims.

### DETAILED DESCRIPTION

Embodiments of the present disclosure, in various aspects, relate to carbonated, flavored, and colorless beverages, as well as syrup and/or powdered forms (e.g., powders and/or granulations) of the beverages that can be mixed with an appropriate amount of a fluid. The carbonated, flavored, and colorless beverage is not a “soda water” as defined in 7 CFR Part 210.11 (a)2 and Part 220.2 (I-1) by the U.S. Department of Agriculture (USDA). The carbonated, flavored, and colorless beverage is exempt from the “soda water” category because the beverage includes at least one nutrient in an amount of at least 5% of the dietary reference daily intake (RDI). Thus, the disclosed beverages may be a dietary supplement from which an individual can obtain at least the part the RDI of at least one nutrient.

In addition, the nutrient is not discretely added to achieve the 5% RDI, and the nutrient is from a naturally-occurring source. In this regard, the disclosed carbonated, flavored, and colorless beverage includes at least 5% RDI of the nutrient from a naturally-occurring source. At least a portion of the nutrient is from acerola juice. “Acerola juice” as used herein means acerola juice and/or acerola juice concentrate (e.g., powder extract and/or syrup).

In general, the carbonated, flavored, and colorless beverage includes, but is not limited to, acerola juice. On average, acerola juice includes about 50 to 60 mgs of naturally-occurring Vitamin C (or ascorbic acid) per ml. In addition, the acerola powder extract includes about 5 to 50% Vitamin C, 5 to 40% Vitamin C, 5 to 30% Vitamin C, or 15 to 25% Vitamin C. The concentration of the Vitamin C in the acerola powder can be adjusted. In addition, the amount of powder used can be adjusted and used to produce the carbonated, flavored, and colorless beverage. Therefore, the amount of acerola juice and/or acerola powder extract can be adjusted accordingly, based on the desired formulation as described in more detail below.

Also, the addition of acerola juice to the beverage does not cause the beverage to change color (e.g., become noncolorless), become cloudy, or substantially affect the taste of the beverage. In another embodiment, a powdered form of the beverage can be mixed with and substantially dissolved in an appropriate amount of a fluid (e.g., water) to form the carbonated, flavored, and colorless beverage.

Now having described the carbonated, flavored, and colorless beverage in general, the following describes some illustrative embodiments of the carbonated, flavored, and colorless beverage. While particular embodiments of the carbonated, flavored, and colorless beverage are described below, there is no intent to limit embodiments of the carbonated, flavored, and colorless beverage to these descriptions. On the contrary, the intent is to cover all alternatives, modifications, and equivalents included within the spirit and scope of embodiments of the present disclosure. In particular, portions of, or the entire, beverage formulation can be made into a powder form to be mixed with an appropriate amount of a fluid.

The disclosed carbonated, flavored, and colorless beverage can include one or more components such as, but not limited to, acerola juice (e.g., powdered extract form, concentrated syrup form, combinations thereof, and the like), carbonated filtered water, and flavoring. In addition, the disclosed carbonated, flavored, and colorless beverage can include components such as, but not limited to, a sweetener (e.g., natural or artificial sweetener), one or more juice concentrates, calcium lactate, citric acid, at least one preservative, a source of Vitamin C from a non-natural source, and/or combinations thereof. Furthermore, the disclosed carbonated, flavored, and colorless beverage can include vitamins and minerals such as, but not limited to, Vitamin A, Vitamin E, Vitamin D, Vitamin K, Vitamin C, thiamin, riboflavin, niacin, Vitamin B6, folate, Vitamin B12, biotin, choline, calcium, phosphorus, magnesium, iron, zinc, iodine, selenium, and/or combinations thereof. It should be noted that a non-juice concentrate could be used as well. The components can be mixed in a liquid, syrup, and/or powder form.

In an embodiment, the components of the carbonated, flavored, and colorless beverage can be mixed and then made into a syrup and/or powder form. In another embodiment, the components can be formed into a powder separately, then an appropriate amount of each powdered component is mixed to form the final powder, which is later added to an appropriate amount of a liquid (e.g., water). In still another embodiment, various combinations of the components can be mixed and formed into a powder, while one or more other (individually or in combination) components can be mixed therewith to form the final powder, which is later added to an appropriate amount of liquid.

The juice concentrate can be selected from, but not limited to, orange juice, grape juice, pear juice, grapefruit juice, white grape juice, apple juice, pineapple juice, mango juice, papaya juice, strawberry juice, pink grapefruit juice, honeydew melon juice, tomato juice, raspberry juice, watermelon juice, lemon juice, tangerine juice, and cherry juice, other fruit juices, and combinations thereof. It should be noted that the juice concentrate could include the nutrient or nutrients described above. The juice concentrate in combination with the acerola juice can be used to achieve at least 5% of the RDI of the nutrient.

The preservative can include, but is not limited to, sodium benzoate, potassium sorbate, potassium benzoate, and combinations thereof.

The flavoring can include, but is not limited to, strawberry flavoring, wildberry flavoring, raspberry flavoring, lemon flavoring, lime flavoring, lemon/lime flavoring, orange flavoring, black cherry flavoring, cherry flavoring, peach flavoring, mango flavoring, watermelon flavoring, kiwi flavoring, fruit punch flavoring, citrus punch flavoring, root beer flavoring, cola flavoring, other fruit flavoring, and combinations thereof.

For example, the disclosed carbonated, flavored, and colorless beverage can include carbonated filtered water, sweetener, calcium lactate, citric acid, acerola juice (e.g., acerola juice and/or acerola juice concentrate (powder extract and/or syrup)), sodium benzoate, potassium sorbate, ascorbic acid, and a flavoring.

The carbonated, flavored, and colorless beverage can be a finished beverage (e.g., ready to serve), a precursor syrup concentrate, a powder concentrate, and combinations thereof. The syrup and/or powder can be mixed with an appropriate amount of carbonated water to produce the finished beverage having at least one nutrient in an amount of at least 5% of the RDI. In general, the syrup is diluted in about a 1:5 ratio of syrup to water in order to produce the finished beverage. In general, the powder is diluted in about a 1:5 ratio of powder to water in order to produce the finished beverage. It should be noted that the dilution ratio can range, depending on, at least in part, the amount of acerola in the syrup or powder, and one skilled in the art could adjust the dilution ratio to adjust for such changes.

In an embodiment of the finished beverage, the amount of acerola juice can range from about 0.0045 to 5 weight % of the finished beverage, from about 0.0045 to 2 weight % of the finished beverage, from about 0.0045 to 1 weight % of the finished beverage, from about 0.0045 to 0.5 weight % of the finished beverage, from about 0.0045 to 0.12 weight % of the finished beverage, from about 0.0045 to 0.11 weight % of the finished beverage, and about 0.1 weight % of the finished beverage, among others. It should be noted that the average amount of vitamin C in acerola is about 56 mgs of vitamin C per 1 ml of acerola juice, or about 15-40 mg of Vitamin C per about 1 g of acerola fruit. In addition it should be noted, the acerola powder extract is about 15 to 25% Vitamin C (e.g., for 1.00 lbs, 0.25 lbs is Vitamin C). Therefore, if the amount of vitamin C varies, then the amount of acerola juice will vary accordingly.

The amount of vitamin C provided by the acerola juice and/or powdered extract can range from about 1 to 1100% RDI, 1 to 500% RDI, 1 to 250% RDI, 1 to 100% RDI, 1 to 50% RDI, 1 to 25% RDI, about 1 to 15% RDI, about 1 to 10% RDI, about 1 to 8% RDI, about 1 to 5% RDI, about 2 to 5% RDI, about 3 to 5% RDI, and about 5% RDI. If appropriate, additional vitamin C can be provided by other juice concentrates to achieve the nutrient level of “at least 5% RDI” required by the USDA in order for the disclosed beverage to be exempt from the “soda water” category.

In addition, the amount of water can range from about 70 to 99 weight % of the beverage, and from 85 to 95 weight % of the finished beverage. Preferably, the water is filtered water to obtain a higher quality of water for the disclosed beverage. The amount of sweetener can range from about 0 to 25 weight % of the finished beverage and from 0 to 10 weight % of the beverage. In general, the other components are less than about 1 weight % of the beverage and one skilled in the art can adjust the weight % of the other components as desired.

In the syrup, the amount of acerola juice and/or powdered extract can range from about 0.01 to 25.6 weight % of the syrup, from about 0.01 to 10.2 weight % of the syrup, from about 0.01 to 5.1 weight % of the syrup, from about 0.01 to 2.6 weight % of the syrup, from about 0.01 to 0.5 weight % of the syrup, from about 0.01 to 0.04 weight % of the syrup, and about 0.04 weight % of the syrup.

In addition, the syrup can include components such as, but not limited to, a flavoring, a sweetener, a juice concentrate, calcium lactate, citric acid, a preservative, a source of Vitamin C from a non-naturally occurring source, other vitamins and minerals, and combinations thereof.

The amount of water can be from about 10 to 99 weight % of the syrup, while the sweetener can be from about 0 to 90 weight % of the syrup. In general, the other components are less than about 2 weight % of the beverage. One skilled in the art can adjust the weight percents of the other components as desired.

It should be noted that the juice concentrate, in addition to the acerola juice, can provide a portion of the nutrient to achieve at least 5% of the daily reference intake. The nutrient can be provided by one or more juices. Therefore, the amount of juice concentrate and acerola juice can be adjusted to achieve the 5% of the reference daily intake.

The disclosed carbonated, flavored, and colorless beverage can be made by mixing in appropriate ratios of the concentrated syrup and/or powder with carbonated water (e.g., about 1:5). The end result should be a carbonated, flavored, and colorless beverage having at least one nutrient in an amount of at least 5% RDI, where at least a portion of the nutrient is from acerola juice. It should be noted that the carbonated water mixed with the syrup and/or powder could include one or more of the components mentioned above such as, but not limited to, a sweetener.

It should be emphasized that the above-described embodiments of the present disclosure are merely possible examples of implementations, and are merely set forth for a clear understanding of the principles of this disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A beverage, comprising:
a flavored beverage, wherein the flavored beverage is carbonated and colorless, and includes at least 5% of the dietary reference daily intake (RDI) for a nutrient selected from an essential vitamin and an essential mineral, wherein the 5% of the RDI for a specified nutrient is from a naturally-occurring source, and wherein the naturally-occurring source is chosen from acerola juice, acerola juice concentrate, acerola powder extract, and combinations thereof.

2. The beverage of claim 1, further comprising components selected from at least one preservative and a second source of the nutrient from a naturally-occurring source.

3. The beverage of claim 2, wherein the naturally-occurring source, the second source of the nutrient, and combinations thereof, achieve at least 5% of the RDI for the nutrient.

4. The beverage of claim 1, further comprising components selected from at least one preservative and a third source of the nutrient from a non-natural source.

5. The beverage of claim 1, wherein the nutrient is Vitamin C.

6. The beverage of claim 1, wherein the nutrient is at least 5% of the RDI per serving.

7. The beverage of claim 1, wherein the nutrient is at least 5% of the RDI per 100 calories.

8. The beverage of claim 7, wherein the nutrient comprises ascorbic acid.

9. The beverage of claim 1, comprising a form selected from: a finished beverage, a precursor syrup concentrate, a powder, individual powder components, and combinations thereof.

10. The beverage of claim 9, further comprising: a flavoring, a sweetener, a juice concentrate, calcium lactate, citric acid, a preservative, a source of Vitamin C from a non-natural source, a source of Vitamin C from a natural source, and combinations thereof.

11. A dietary supplement, wherein the supplement comprises:
a nutritive beverage, the beverage comprising carbonated water and acerola juice.

12. The nutritive beverage of claim 11, wherein the acerola juice comprises acerola juice concentrate.

13. A process for making a nutritive beverage product, the process comprising the steps of:
providing acerola juice and carbonated water;
combining acerola juice and carbonated water; and
adjusting acerola juice concentration in the combination of acerola juice and carbonated water to yield at least 5% of dietary reference daily intake (RDI) of Vitamin C.

14. The process of claim 13, wherein the acerola juice is in a form chosen from a precursor syrup concentrate, a powder, and combinations thereof.

15. The process of claim 13, wherein the acerola juice is in a form of a precursor syrup concentrate, and further comprising the step of:
diluting the acerola syrup in about a 1:5 ratio of acerola syrup to carbonated water.

16. The process of claim 13, wherein the acerola juice is in a form of a powder concentrate, and further comprising the step of:
diluting the acerola powder in about a 1:5 ratio of acerola powder to carbonated water.

17. The process of claim 13, wherein the acerola juice is in a form of a precursor syrup concentrate, wherein the precursor syrup concentrate further comprises an ingredient chosen from: a flavoring, a sweetener, a juice concentrate, calcium lactate, citric acid, a preservative, a source of Vitamin C from a non-naturally occurring source, Vitamin A, Vitamin E, Vitamin D, Vitamin K, Vitamin C, thiamin, riboflavin, niacin, Vitamin B6, folate, Vitamin B12, biotin, choline, calcium, phosphorus, magnesium, iron, zinc, iodine, selenium, and combinations thereof.
